(19) United States
(12) Patent Application Publication
(10) Pub. No.: US 2026/0101075 A1
(43) Pub. Date: Apr. 9, 2026

(54) METHOD AND SERVER FOR PROVIDING CONTENT RECOMMENDATION

(71) Applicant: Samsung Electronics Co., Ltd., Suwon-si (KR)

(72) Inventors: Dosung KIM, Suwon-si (KR); Yeongkeun KWON, Suwon-si (KR); Hoshin SON, Suwon-si (KR)

(73) Assignee: Samsung Electronics Co., Ltd., Suwon-si (KR)

(21) Appl. No.: 19/347,914

(22) Filed: Oct. 2, 2025

Related U.S. Application Data
(63) Continuation of application No. PCT/KR2025/014062, filed on Sep. 10, 2025.

(30) Foreign Application Priority Data
Oct. 4, 2024 (KR) 10-2024-0134982

(51) Int. Cl. H04N 21/258; H04N 21/234; H04N 21/266

(52) U.S. Cl. CPC H04N 21/25891; H04N 21/23418; H04N 21/266

(57) ABSTRACT

Provided is a method of providing, by a server, user-preferred content. The method may include retrieving, based on content information of current content, one or more pieces of edited content corresponding to the current content, identifying a preference for an editing style, the preference being based on a viewing history, and identifying and providing recommended content among the one or more pieces of edited content, based on the preference for the editing style.

### CROSS-REFERENCE TO RELATED APPLICATIONS

This application is a continuation of International Application No. PCT/KR2025/014062, filed September 10, 2025, and claims foreign priority to Korean Application No. 10-2024-0134982, filed October 4, 2024, and which are incorporated herein by reference in their entireties.

### TECHNICAL FIELD

The disclosure relates to a method, a server and an electronic device, for providing a recommendation of edited content reflecting a user's preferences.

### BACKGROUND ART

Recently, as various content platforms have provided much content, content consumption patterns have also changed. Users no longer view content at fixed broadcast times but tend to freely select and view desired content at desired times. A content recommendation algorithm for recommending user content that the user may like determines the content based on the viewing history of the user, the quality of the content, the number of views, and the like. However, recently, a large amount of content is being reproduced, and even content with the same subject matter tends to elicit different user preferences depending on the editing style. In particular, there may be multiple edited versions for one original video. Accordingly, in order to recommend content suitable for users who prefer different editing styles, it may be required to accurately identify whether a video has been edited and the style of editing used.

### DISCLOSURE

### Technical Solution

According to an aspect of the disclosure, a method performed by a server may be provided. The method may include retrieving, based on content information of current content being played on a user device, one or more pieces of edited content corresponding to the current content. The method may include identifying a preference for an editing style, the preference being based on a viewing history. The method may include identifying recommended content among the one or more pieces of edited content based on the preference for the editing style. The method may include transmitting information about the recommended content to the user device.

According to an aspect of the disclosure, a server may be provided. The server may include a communication interface, at least one processor, and a memory storing instructions. The instructions, when executed by the at least one processor, may cause the server to retrieve, based on content information of current content being played on a user device, one or more pieces of edited content corresponding to the current content, wherein the content information is received from the user device through the communication interface. The instructions, when executed by the at least one processor, may cause the server to identify a preference for an editing style, the preference being based on a viewing history. The instructions, when executed by the at least one processor, may cause the server to identify recommended content among the one or more pieces of edited content based on the preference for the editing style. The instructions, when executed by the at least one processor, may cause the server to transmit, through the communication interface, information about the recommended content to the user device.

According to an aspect of the disclosure, an electronic device for providing user-preferred content may be provided. The electronic device may include a communication interface, at least one processor, and a memory storing instructions. The instructions, when executed by the at least one processor, may cause the electronic device to retrieve, based on content information of current content, one or more pieces of edited content corresponding to the current content. The instructions, when executed by the at least one processor, may cause the electronic device to identify a preference for an editing style, the preference being based on a viewing history. The instructions, when executed by the at least one processor, may cause the electronic device to identify recommended content among the one or more pieces of edited content based on the preference for the editing style. The instructions, when executed by the at least one processor, may cause the electronic device to perform control such that the recommended content is displayed on a screen of the electronic device.

According to an aspect of the disclosure, a non-transitory computer-readable recording medium having recorded thereon a program for executing any one of the above or following methods for causing an electronic device and/or a server to provide recommended content may be provided.

### DESCRIPTION OF DRAWINGS

FIG. 1 is a diagram for describing an example of an operation of providing, by a server, a recommendation of edited content, according to an embodiment of the disclosure.

FIG. 2A is a flowchart for describing an operation of providing, by a server, a recommendation of edited content, according to an embodiment of the disclosure.

FIG. 2B is a flowchart for describing an operation of providing, by a server, a recommendation of edited content, according to an embodiment of the disclosure.

FIG. 3 is a diagram for describing an operation of managing, by a server, edited content, according to an embodiment of the disclosure.

FIG. 4 is a diagram for describing an operation of determining, by a server, original content and edited content, according to an embodiment of the disclosure.

FIG. 5 is a diagram for describing original content and edited content, according to an embodiment of the disclosure.

FIG. 6 is a diagram for describing an operation of analyzing, by a server, an editing style of content and an editing style preference, according to an embodiment of the disclosure.

FIG. 7 is a diagram for describing an operation of determining, by a server, recommended content, based on a device group corresponding to a user device, according to an embodiment of the disclosure.

FIG. 8 is a diagram for describing an example of selecting, by a server, a device group corresponding to a user device, according to an embodiment of the disclosure.

FIG. 9A is a diagram for describing an example of providing, by a user device, recommended edited content, according to an embodiment of the disclosure.

FIG. 9B is a diagram for describing an example of providing, by a user device, recommended edited content, according to an embodiment of the disclosure.

FIG. 9C is a diagram for describing an example of providing, by a user device, recommended edited content, according to an embodiment of the disclosure.

FIG. 10A is a flowchart for describing an example of an operation of a recommended content providing server, according to an embodiment of the disclosure.

FIG. 10B is a flowchart for describing an example of an operation of a recommended content providing system, according to an embodiment of the disclosure.

FIG. 11 is a block diagram illustrating a configuration of a server according to an embodiment of the disclosure.

FIG. 12 is a block diagram illustrating a configuration of a user device according to an embodiment of the disclosure.

### MODE FOR INVENTION

Terms used herein will be briefly described and then the disclosure will be described in detail. Throughout the disclosure, expressions such as "at least one of a, b or c", "at least one of a, b, or c", "at least one of a, b and c", "at least one of a, b, and c" may include only a, only b, only c, both a and b, both a and c, both b and c, all of a, b, and c, or variations thereof.

The terms used herein are those general terms currently widely used in the art in consideration of functions in the disclosure, but the terms may vary according to the intentions of those of ordinary skill in the art, precedents, or new technology in the art. Also, in some cases, there may be terms that are optionally selected by the applicant, and the meanings thereof will be described in detail in the corresponding portions of the disclosure. Thus, the terms used herein should be understood not as simple names but based on the meanings of the terms and the overall description of the disclosure.

As used herein, the singular forms "a," "an," and "the" may include the plural forms as well, unless the context clearly indicates otherwise. As an example, the disclosure of "a server" that performs various operations may include more than one server to perform the operations. Unless otherwise defined, all terms (including technical or scientific terms) used herein may have the same meanings as commonly understood by those of ordinary skill in the art of the disclosure. Although terms including ordinals such as "first" or "second" may be used herein to describe various elements or components, these elements or components should not be limited by these terms. These terms are merely used to distinguish one element from other elements.

Throughout the disclosure, when something is referred to as "including" an element, one or more other elements may be further included unless otherwise specified. Also, as used herein, the terms such as "units" and "modules" may refer to units that perform at least one function or operation, and the units may be implemented as hardware or software or a combination of hardware and software.

Hereinafter, an embodiment of the disclosure will be described in detail with reference to the accompanying drawings so that those of ordinary skill in the art may easily implement the disclosure. However, the disclosure may be embodied in many different forms and should not be construed as being limited to the embodiment set forth herein. Also, portions irrelevant to the description of the disclosure will be omitted in the drawings for a clear description of the disclosure, and like reference numerals will denote like elements throughout the specification.

Hereinafter, the disclosure will be described with reference to the accompanying drawings.

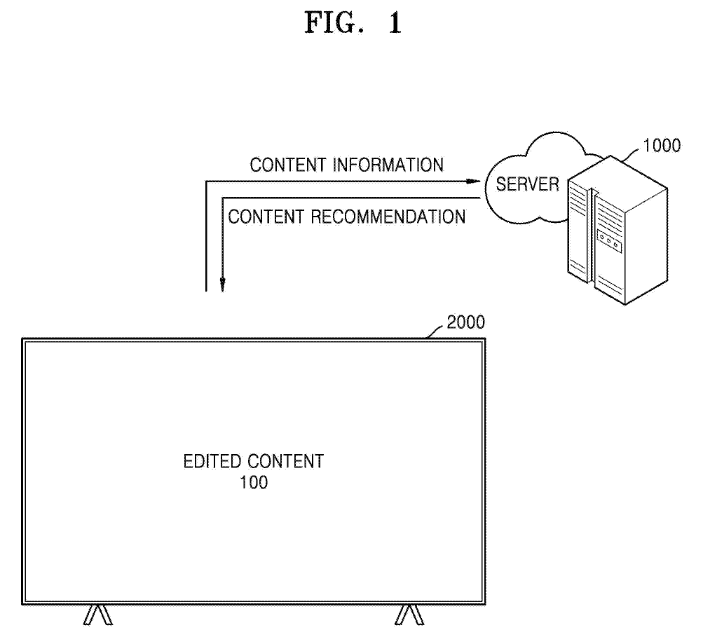

FIG. 1 is a diagram for describing an example of an operation of providing, by a server, a recommendation of edited content according to an embodiment of the disclosure.

In an embodiment of the disclosure, a system for providing a recommendation of edited content 100 may include a server 1000 and a user device 2000.

The user device 2000 may be a device that includes a display to output images and/or moving images. For example, the user device 2000 may include a smart television (TV), a smartphone, a tablet personal computer (PC), a laptop PC, and a frame-type display; however, the disclosure is not limited thereto and the user device 2000 may be implemented as various types and forms of electronic devices including a display. The user device 2000 may be an electronic device in which the edited content 100 recommended by the system is displayed on a display. Alternatively, the user device 2000 may be an electronic device such as a set-top box or a desktop PC that does not include a display and may be connected to a separate display device to provide the edited content 100.

The server 1000 may perform a series of functions for enabling a recommendation of the edited content 100 in the user device 2000 to be provided to the user. The server 1000 may receive content information (e.g., information about content currently being played) from the user device 2000, determine recommended content based on the content information and information (e.g., device use history information) obtained from the user device 2000, and transmit a content recommendation to the user device 2000. The content recommendation may be the edited content 100 that matches the user's preferred editing style.

The edited content 100 may refer to content that has the same basic content as the content being played in the user device 2000 but is different therefrom in that it has been edited in a different way. Various edited versions derived from the original content may be different results depending on whether they have been edited and the editing method thereof, even when they have been edited for the same source. Moreover, the user of the user device 2000 may have his or her own preferred editing style. For example, the user may prefer a summary-type editing style with only a main scene edited in the original content, or an extension-type editing style with additional information (e.g., subtitle description) inserted into the original content, and each user may have a different editing style preference. Thus, the server 1000 may analyze whether the content has been edited and the editing style thereof and may select the edited content 100 corresponding to the user's editing style preference and provide the same as a recommendation.

Particular operations of the server 1000 and the user device 2000 for providing a recommendation of the edited content 100 to the user will be described in more detail with reference to the following drawings described below.

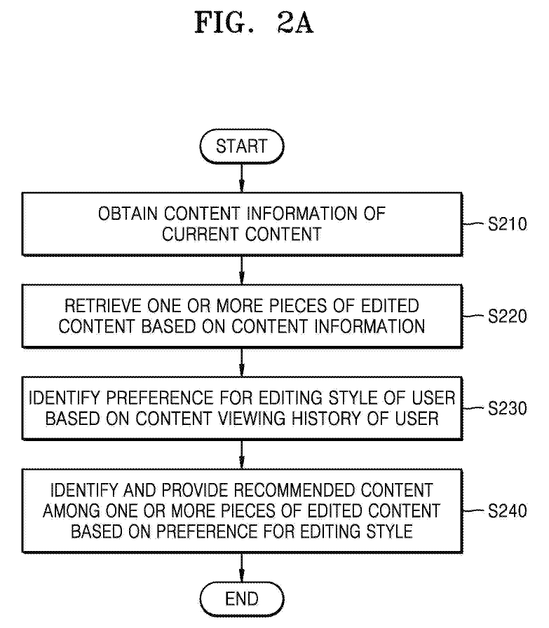

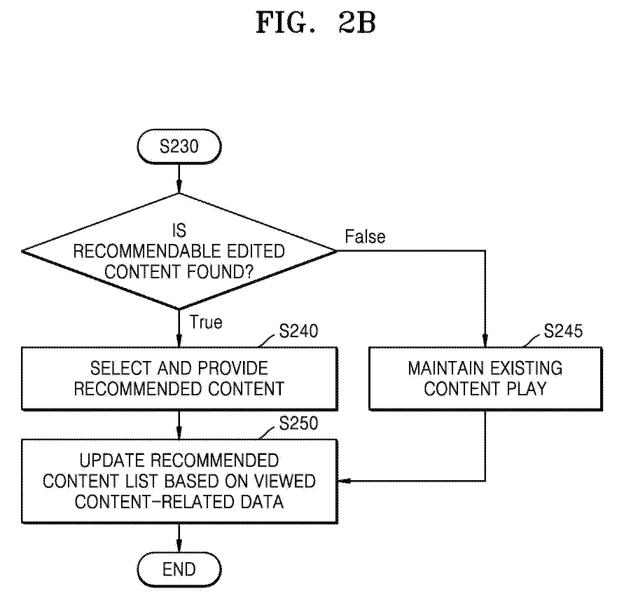

FIG. 2A is a flowchart for describing an operation of providing, by a server, a recommendation of edited content according to an embodiment of the disclosure.

In operation S210, the server 1000 may obtain content information of a current content. The current content may refer to content being played on the user device 2000. The content may refer to video content.

The content information may include metadata of the content. For example, the content information may include metadata of the content, such as a title, a producer, a release date, a genre, a play time, and identification information; however, the disclosure is not limited thereto. When the current content is edited content, the content information may include, but is not limited to, metadata related to editing, such as an original content link, an editor, a content description, a tag, and music information.

In an embodiment of the disclosure, the server 1000 may receive content information from the user device 2000 on which content is played. In an embodiment of the disclosure, the server 1000 may receive content information from a content server that allows content to be provided to the user device 2000. In an embodiment of the disclosure, the server 1000 may receive content from the user device 2000 or the content server and extract content information from the received content.

The obtainment of the content information may mean that the server 1000 has been requested to provide recommended content based on the current content. When the content information is obtained, the server 1000 may start a series of operations for determining recommended content to be provided to the user based on the user's preference for an editing style and pieces of content stored in a content storage.

In operation S220, the server 1000 may retrieve one or more pieces of edited content corresponding to the current content based on the content information.

The edited content corresponding to the current content may be an edited version using the same source as the current content as an original version. The server 1000 may store edited versions using the same source as a 'content collection' unit. The editing style of pieces of edited content in the content collection may be different for each of the pieces of edited content.

In an embodiment of the disclosure, based on the content information, the server 1000 may identify whether the current content being viewed by the user is an original version or an edited version. When the current content is an original version, the server 1000 may identify a content collection of the current content. When the current content is an edited version, the server 1000 may retrieve an original version of the current content and identify a content collection corresponding to the retrieved original version, or when the current content is an edited version, the server 1000 may identify a content collection including edited versions corresponding to the current content.

In an embodiment of the disclosure, the server 1000 may analyze the current content. The server 1000 may analyze screen elements and voice elements of the current content to identify a content collection including edited versions corresponding to the current content.

In operation S230, the server 1000 may identify a preference for an editing style based on the user's content viewing history.

In an embodiment of the disclosure, the server 1000 may obtain a user's preference for an editing style based on the user's content viewing history. The server 1000 may receive the user's content viewing history from the user device 2000, analyze the content viewing history, and calculate a preference for an editing style indicating which style of edited content the user prefers. The preference for the editing style may be calculated at a time before a recommendation of the edited content is provided.

The preference for the editing style may be calculated based on various editing style elements. The preference for the editing style may include, for example, at least one of a preference for a subtitle, a preference for a non-speech segment, or a preference for an effective viewing segment, however, the disclosure is not limited thereto.

In operation S240, the server 1000 may identify and provide recommended content among the one or more pieces of edited content based on the preference for the editing style.

In an embodiment of the disclosure, with respect to the pieces of edited content stored in the content storage, the server 1000 may calculate and store an editing style score indicating in which style each piece of content has been edited. The editing style score may match the editing style preference. The server 1000 may select content corresponding to the preference for the editing style from among a content collection including one or more pieces of edited content corresponding to the current content. For example, the server 1000 may select recommended content to be provided to the user, based on at least one of a preference for a subtitle, a preference for a non-speech segment, or a preference for an effective viewing segment. The recommended content may be content edited to match the editing style preferred by the user.

In an embodiment of the disclosure, when the user prefers the original version, the server 1000 may provide the original content. In this case, when the current content is the original content, the server 1000 may maintain the play of the current content without changing the content. Alternatively, when the current content is the edited content, the server 1000 may determine the original content corresponding to the current content as the recommended content.

In an embodiment of the disclosure, when there are a plurality of pieces of edited content corresponding to the user's preference for the editing style, the server 1000 may provide a recommended content list including the plurality of pieces of edited content.

In an embodiment of the disclosure, the server 1000 may edit the current content based on the user's preference for the editing style. For example, the server 1000 may edit the current content based on at least one of a preference for a subtitle, a preference for a non-speech segment, or a preference for an effective viewing segment and provide the edited current content as the recommended content. Particularly, when the user prefers content without a subtitle, the server 1000 may edit the content by performing a subtitle recognition and removal operation on the current content.

The server 1000 may transmit information about the recommended content to the user device 2000. For example, the server 1000 may transmit at least one of the recommended content, the recommended content list, or metadata of the recommended content to the user device 2000. The user device 2000 may provide a recommendation to the user by using the information about the recommended content received from the server 1000. For example, the user device 2000 may cause the recommended content to be automatically played based on the information about the recommended content. For example, the user device 2000 may display information indicating that there is the recommended content. The information indicating that there is the recommended content may be various forms of visual or auditory information, such as a notification and a thumbnail of the recommended content.

FIG. 2B is a flowchart for describing an operation of providing, by a server, a recommendation of edited content according to an embodiment of the disclosure.

In describing FIG. 2B, redundant descriptions already given in the description of FIG. 2A will be omitted for conciseness.

In operation S230, the server 1000 may identify a user's preference for an editing style calculated based on the user's content viewing history. Thereafter, based on the user's preference for the editing style, the server 1000 may identify whether there is recommendable content. For example, the server 1000 may retrieve edited content matching the user's preference for the editing style, in a content collection including pieces of edited content corresponding to the current content.

When recommendable edited content is found, the server 1000 may select recommended content and provide the same to the user device 2000 (S240).

When no recommendable edited content is found or when it is determined that the user is already viewing preferred content, the server 1000 may maintain the play of the existing content (S245).

In operation S250, the server 1000 may update the recommended content list based on the viewed content-related information.

The server 1000 may obtain the viewing history, for example, the viewed content-related information, from the user device 2000. For example, the viewed content-related information may include whether the viewed content is original/edited, the editing style, and the viewing time; however, the disclosure is not limited thereto.

For example, the recommended content provided by the server 1000 may have been played on the user device. Alternatively, even when the server 1000 has provided the recommended content, the recommended content may not have been played on the user device 2000 due to a reason such as the user rejecting the recommended content. The server 1000 may update the user's preference for the editing style based on information related to the content viewed on the user device 2000. The server 1000 may update the recommended content list based on the updated preference for the editing style. For example, when the user prefers content edited to have a shorter non-speech segment in the video, pieces of edited content with a shorter non-speech segment in the recommended content list may be updated as recommended content.

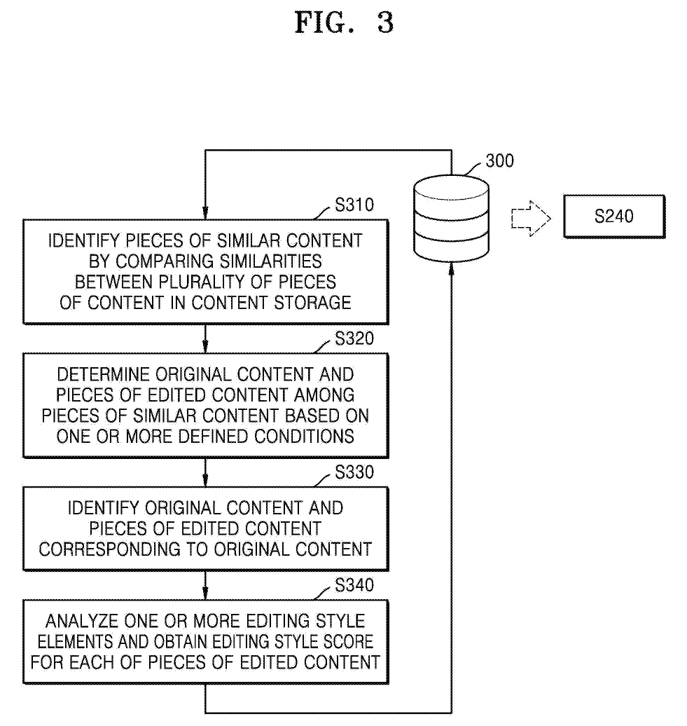

FIG. 3 is a diagram for describing an operation of managing, by a server, edited content according to an embodiment of the disclosure.

In an embodiment of the disclosure, with respect to pieces of edited content stored in a content storage 300, the server 1000 may calculate and store an editing style score indicating in which style each piece of content has been edited. The editing style score may be calculated at a time before a recommendation of the edited content is provided.

In operation S310, the server 1000 may identify pieces of similar content by comparing similarities between a plurality of pieces of content in the content storage 300. Herein, the pieces of similar content may refer to an original content source and pieces of content (e.g., edited versions) to which a certain modification has been applied based on the original content source. The server 1000 may analyze the similarity between pieces of content stored in the content storage 300 by using various algorithms and technologies for identifying pieces of similar content.

For example, the server 1000 may extract a frame of each piece of video content as an image and identify pieces of similar content by using a Python's Pillow library for comparing similarities between images, Perceptual Hashing for comparing similarities between videos, Fuzzy Matching for comparing similarities between texts included in a video, or the like. The method by which the server 1000 compares similarities between pieces of content is not limited to the above examples, and various techniques may be used to achieve the purpose of similarity analysis.

In operation S320, the server 1000 may determine original content and pieces of edited content among the pieces of similar content based on one or more defined conditions.

The one or more defined conditions may refer to conditions for determining original content. For example, the defined condition may include determining the content with the oldest generation time among the pieces of similar content as the original content.

The server 1000 may determine original content and pieces of edited content using the original content as a source and may store the original content and the pieces of edited content in units of 'content collection', which is a unit for distinguishing pieces of similar content. The server 1000 may perform a similar content analysis on the pieces of content stored in the content storage 300 and generate a plurality of content collections by determining and classifying original content and pieces of edited content. For example, a first content collection may include first original content and first pieces of edited content, which are edited versions of the first original content, and a second content collection may include second original content and second pieces of edited content, which are edited versions of the second original content.

In operation S330, the server 1000 may identify original content and pieces of edited content corresponding to the original content.

As a result of the server 1000 performing the content similarity analysis, a plurality of content collections in which edited versions are collected corresponding to each original version may be generated. The server 1000 may analyze the editing style of pieces of edited content included in each of the content collections. For example, the server 1000 may identify the first original content and the first pieces of edited content in order to analyze the editing style of the first pieces of edited content included in the first content collection. In the same way, the server 1000 may identify an original content included in another content collection and edited content corresponding to the original content.

In operation S340, the server 1000 may analyze one or more editing style elements and obtain an editing style score for each of the pieces of edited content.

The editing style element may refer to an element for evaluating how the edited content has been edited from the original content. For example, the editing style element may include a subtitle, a non-speech segment, and an effective viewing segment (a skipped segment); however, the disclosure is not limited thereto. The server 1000 may calculate an editing style score corresponding to each editing style element. An operation of the server 1000 for calculating the editing style score will be described below.

In an embodiment of the disclosure, the server 1000 may generate content collections including {original-edited versions} with respect to a plurality of pieces of content in the content storage and calculate an editing style score for each of the pieces of edited content included in the content collections. The calculated editing style score may be used in operation S240 in which the server 1000 selects recommended content from among the one or more pieces of edited content based on the preference for the editing style. For example, the server 1000 may match the user's preference for the editing style and the editing style score of the edited content and select content edited to match the user's preference as recommended content.

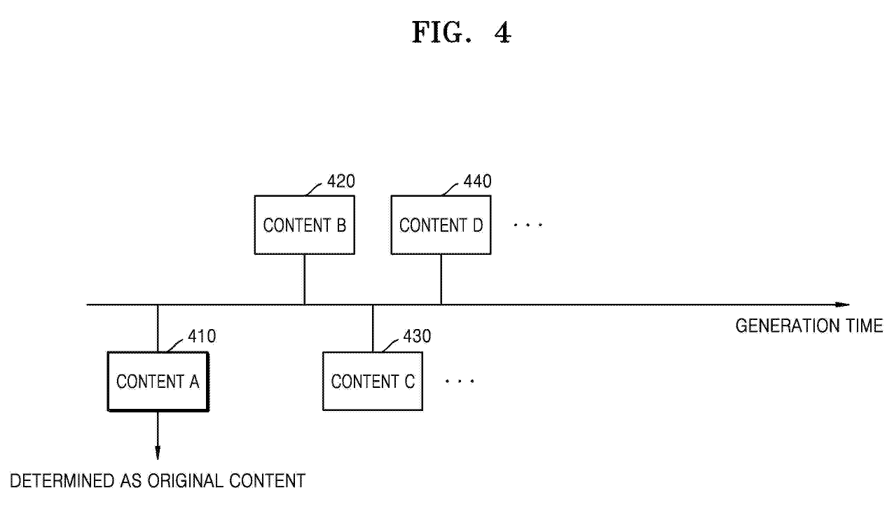

FIG. 4 is a diagram for describing an operation of determining, by a server, original content and edited content according to an embodiment of the disclosure.

In an embodiment of the disclosure, the server 1000 may analyze similarities between pieces of content and identify pieces of similar content. The pieces of similar content may include original content and edited versions of the original content. The server 1000 may analyze the similarities between pieces of content by using various algorithms and technologies for identifying pieces of similar content. For example, the server 1000 may compare the similarities between pieces of content by using a Python's Pillow library, Perceptual Hashing, Fuzzy Matching, or the like; however, the disclosure is not limited thereto.

When the server 1000 classifies pieces of similar content, pieces of classified content may be included in one content collection. For example, the content collection may include content A 410, content B 420, content C 430, content D 440, …, and the like that are classified as pieces of similar content.

The server 1000 may determine original content and pieces of edited content among the pieces of similar content based on one or more defined conditions.

The one or more defined conditions may refer to conditions for determining original content. The defined condition may include determining the content with the oldest generation time among the pieces of similar content as the original content.

For example, based on metadata of the pieces of content 410, 420, 430, and 440 in the content collection, the server 1000 may identify the generation time of the content and list the pieces of content in chronological order. Among the pieces of content 410, 420, 430, and 440 in the content collection, the server 1000 may determine the content A 410 with the oldest generation time as the original content. In this case, the other pieces of content such as the content B 420, the content C 430, and the content D 440 may be considered as edited versions of the content A 410 that is the original content.

In an embodiment of the disclosure, the defined conditions by which the server 1000 determines the original content may include an exception handling condition.

For example, when content is not complete content (e.g., a trailer) even when it has an old generation time, the server 1000 may apply the exception handling condition to exclude the content from the original version or classify the content into two or more original versions (e.g., Short and Long) according to the length of the content. Also, the server 1000 may determine whether each piece of content is an original version, through analysis of the creator information and title of the content.

For example, even when the content has the later generation time, when there is more popular content due to the influence of an editing element or the like, the server 1000 may use a factor representing popularity, such as the number of views, as a factor to be reflected when recommending the content.

For example, even when the content has the oldest generation time, when the content is currently deleted content, the server 1000 may not consider the content as an original version. In this case, with reference to the deletion information, the server 1000 may process the original content as being removed and replace the original version with another piece of similar content.

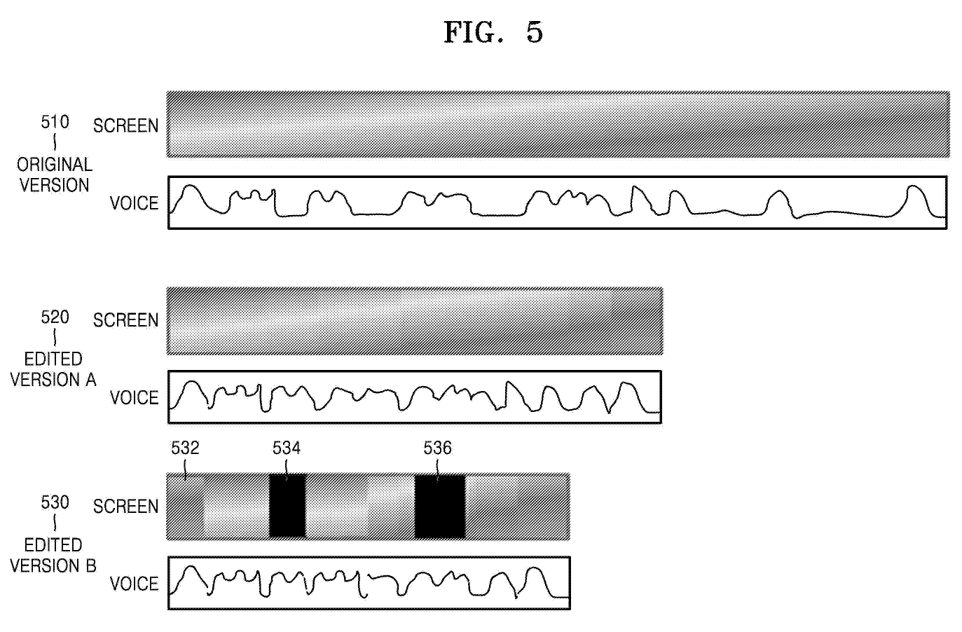

FIG. 5 is a diagram for describing original content and edited content according to an embodiment of the disclosure.

Referring to FIG. 5, original content 510, and an edited version A 520 and an edited version B 530, which are pieces of edited content representing examples of edited versions of the original content, are illustrated. Screen data and voice data of the original content 510 may represent unedited consecutive screen data and voice data.

In an embodiment of the disclosure, because each content producer/editor has a different editing style, edited versions generated based on the original content 510 may include different screen data and voice data.

For example, referring to the edited version A 520, the edited version A 520 may represent the result of cutting out screen data and voice data at certain intervals in the original content 510. In other words, the edited version A 520 may represent a summary version retaining only the speech segments from the original content 510 by cutting out only non-speech segments from the original content 510. Alternatively, the edited version A 520 may represent a summary version generated by cutting out the other segments from the original content 510 while leaving only effective scenes.

As another example, referring to the edited version B 530, the edited version B 530 may represent the result of editing the original content 510 by adding the editor's re-creation elements to the original content 510. In other words, the edited version B 530 may represent not the case of cutting out by using only the elements of the original content 510 but the case of including the repetition or order change of certain segments, the insertion of other content, and the like.

For example, the screen and voice that have existed in the latter part of a moving image in the original content 510 may be inserted into a first time segment 532 that is a beginning segment of the content. The screen and voice that have not existed in the original content 510 may be inserted into a second time segment 534 and a third time segment 536 that are middle time segments of the content. Also, some sections of the screen and voice included in the middle of the original content 510 may be cut out to include a skip effect. In other words, the edited version B 530 may represent a secondary creation newly generated based on the original content 510.

According to an embodiment of the disclosure, the server 1000 may analyze defined editing style elements to classify pieces of content based on the editing style. For example, the server 1000 may analyze at least one of the defined editing style elements including a subtitle, a non-speech segment, and a skipped segment and calculate an editing style score corresponding to each of the pieces of edited content. The editing style score may include a detailed score corresponding to each of the editing style elements. For example, the server 1000 may calculate an editing style score corresponding to the edit version A 520 and an editing style score corresponding to the edit version B 530.

According to an embodiment of the disclosure, the server 1000 may analyze which content the user views and calculate a user's preference for an editing style. For example, the server 1000 may calculate a preference for an editing style indicating whether the user prefers content with more/fewer subtitles, whether the user prefers content with more/fewer non-speech segments, or whether the user prefers content with more/fewer skipped segments.

Based on the user's preference for the editing style and the editing style score of the edited content, the server 1000 may select and recommend content edited in the style preferred by the user, instead of a recommendation simply reflecting the viewing history, the preference for the subject, and the like.

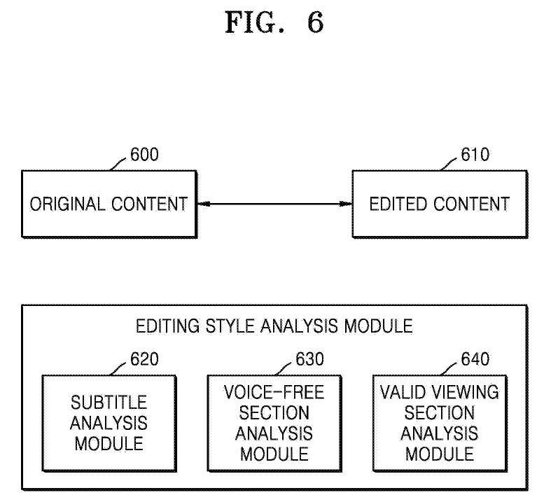

FIG. 6 is a diagram for describing an operation of analyzing, by a server, an editing style of content and a preference for the editing style according to an embodiment of the disclosure.

In an embodiment of the disclosure, the server 1000 may perform an editing style analysis operation for evaluating an editing style by comparing original content 600 with edited content 610. By using an editing style analysis module, the server 1000 may analyze how the edited content 610 is edited compared to the original content 600. For example, the editing style analysis module may include a subtitle analysis module 620, a non-speech segment analysis module 630, and an effective viewing segment analysis module 640; however, the disclosure is not limited thereto. Each of the modules may represent a code unit for performing a particular function. An operation of each of the modules may be a configuration in which a desired function is implemented by processing the program or instructions stored in the memory included in the server 1000, by at least one processor included in the server 1000.

The subtitle analysis module 620 may quantitatively analyze the amount of subtitles included in the edited content 610 compared to the original content 600. The subtitles may refer to all types of text (e.g., character dialogue, effect description, sound description, and text inserted by an editor) displayed in the content.

The subtitle analysis module 620 may extract one or more frames from the video content. The extracted frames may be extracted at certain frame intervals. The subtitle analysis module 620 may detect text from the extracted frames and identify the subtitle in each frame. For example, the text detection may be performed by using optical character recognition (OCR) or by using an artificial intelligence-based text detection model. For example, the text detection model may be implemented based on a convolutional neural network (CNN) for processing an image to detect and recognize a text area; however, the disclosure is not limited thereto.

The subtitle analysis module 620 may calculate a subtitle score representing the amount of subtitles added to or removed from the edited content 610 compared to the original content 600. For example, the value of the subtitle score may increase as the amount of subtitles added to the edited content 610 compared to the original content 600 increases.

In an embodiment of the disclosure, the subtitle analysis module 620 may calculate a preference for a subtitle among the user-preferred editing styles. The subtitle analysis module 620 may calculate a preference for a subtitle based on the subtitle analysis of pieces of content included in the user's viewing history. For example, the history in which the user has viewed content with a large amount of subtitles increases, the subtitle preference may be calculated as being higher. In other words, the subtitle analysis module 620 may reflect the user viewing history (e.g., the user prefers content with a high subtitle score) in the subtitle preference.

The non-speech segment analysis module 630 may quantitatively analyze the length of the non-speech segment of the edited content 610 compared to the original content 600. The non-speech segment may refer to a segment in the content where there is no "speech" that is distinguished from background sound or other noise. For example, when the editor generates the edited content 610, when the editor inserts his/her own or other person’s voice into the original content 600, the length of the non-speech segment of the edited content 610 may decrease compared to the original content 600. Alternatively, when the editor generates the edited content 610, when the editor cuts out a segment without speech from the original content 600, the length of the non-speech segment of the edited content 610 may decrease compared to the original content 600. Alternatively, when the editor generates the edited content 610, when the editor overwrites the original content 600 with non-voice audio or inserts a new content without voice, the length of the non-speech segment of the edited content 610 may increase.

The non-speech segment analysis module 630 may detect voice from the video content and identify a speech segment and a non-speech segment. For example, the voice detection may be performed by using analysis of the energy of an audio signal or analysis in the frequency domain or by using an artificial intelligence-based voice detection model. For example, the voice detection model may be implemented based on a recurrent neural network (RNN) capable of learning and processing the time-series characteristics of a voice signal; however, the disclosure is not limited thereto.

With respect to the edited content 610, the non-speech segment analysis module 630 may calculate a non-speech segment score representing the length of a speech segment that has increased or decreased. For example, the non-speech segment score may be such that the non-speech segment score decreases as the length of the non-speech segment in the edited content 610 decreases compared to the original content 600. Particularly, when the average non-speech segment length of the original content 600 is 3 seconds and the average non-speech segment length of the edited content 600 is 0.5 seconds, the original content 600 may have a higher non-speech segment score than the edited content 610.

In an embodiment of the disclosure, the non-speech segment analysis module 630 may calculate a preference for a non-speech segment among the user-preferred editing styles. The non-speech segment analysis module 630 may calculate a preference for the non-speech segment based on the non-speech segment analysis on the pieces of content included in the user's viewing history. For example, as the history in which the user has viewed content with a short non-speech segment (e.g., a content summary version with the non-speech segment removed) increases, the user's preference for the non-speech segment may be calculated as being higher. In other words, as the user more prefers content with a low non-speech segment score, the user's preference for the non-speech segment may be calculated as being higher. In an embodiment of the disclosure, the non-speech segment analysis module 630 may reflect the user's viewing history (e.g., the length or the number of times the content is fast-forwarded/skipped) into the non-speech segment preference.

The effective viewing segment analysis module 640 may quantitatively analyze the length of the effective viewing segment of the edited content 610 compared to the original content 600. The effective viewing segment may include a section including a scene most viewed by users in the content, a section actually viewed by content skipping, and a section including a main scene detected based on a scene change in the content.

The effective viewing segment analysis module 640 may detect an effective viewing segment from the video content. For example, the effective viewing segment analysis module may collect viewing history data about the original content 600, the edited content 610, and another piece of edited content corresponding to the original content 600 and detect a section including a scene most viewed by viewers in the content collection. Alternatively, for example, the effective viewing segment analysis module 640 may detect a scene switch of the original content 600, the edited content 610, and another piece of edited content corresponding to the original content 600 by using an analysis method such as histogram analysis or edge detection and may group similar scenes by using clustering. Based on the clustering results, the effective viewing segment analysis module 640 may detect main scenes that are included above a certain standard in the original content 600, the edited content 610, and another piece of edited content corresponding to the original content 600.

With respect to the edited content 610, the effective viewing segment analysis module 640 may calculate an effective viewing segment score representing the degree of inclusion of the effective viewing segment including the main scene. For example, the effective viewing segment score may increase as the edited content 610 includes more sections including the main scene of the original content 600.

In an embodiment of the disclosure, the effective viewing segment analysis module 640 may calculate a preference for an effective viewing segment among the user-preferred editing styles. The effective viewing segment analysis module 640 may calculate a preference for the effective viewing segment based on the effective viewing segment analysis on the pieces of content included in the user's viewing history. For example, when the user fast-forwards or skips the content or frequently views the main scene, the user's effective viewing segment preference may be calculated as being high. In an embodiment of the disclosure, the effective viewing segment analysis module 640 may reflect the user's viewing history (e.g., the length or the number of times the content is fast-forwarded/skipped) into the effective viewing segment preference.

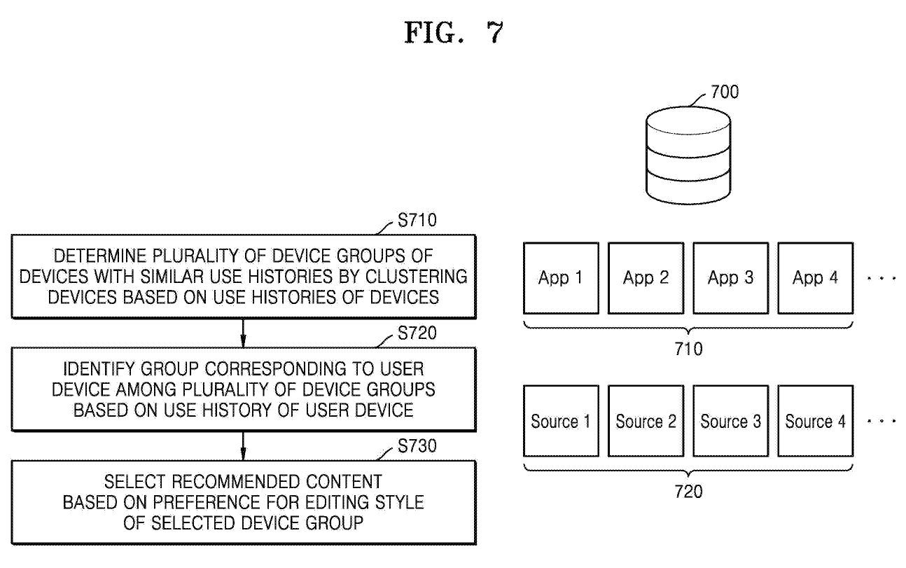

FIG. 7 is a diagram for describing an operation of determining, by a server, recommended content based on a device group corresponding to a user device according to an embodiment of the disclosure.

In an embodiment of the disclosure, the server 1000 may include a device use history database 700. The device use history database 700 may refer to a use history data collection stored in the storage of the server 1000. The device use history database 700 may store the use histories of the user device 2000 and other users' devices.

The device use history may include the use history of applications 710 installed in the device and the use history of sources 720 used in connection with the device. For example, the applications 710 may include an OTT platform application, a video application, and a game application; however, the disclosure is not limited thereto. For example, the sources 720 may include an OTT box, a game console, a set-top box, a desktop PC, and a laptop PC; however, the disclosure is not limited thereto.

The device use history may include the use history related to the content viewed on the device. For example, the device use history may include content information and content-related information. For example, the content information may include content metadata including the title, the producer, the release date, the genre, the play time, and the identification information of the content; however, the disclosure is not limited thereto. For example, the content-related information may include the history of viewed content, viewing time zones, viewing time lengths, and viewing-related operations (e.g., fast forward and skip); however, the disclosure is not limited thereto.

In an embodiment of the disclosure, the server 1000 may group devices by using the device use history database 700. The server 1000 may select edited content to be recommended to the user, based on the preference for the editing style of a device group having similar use histories to the user device 2000.

In operation S710, the server 1000 may determine a plurality of device groups of devices with similar use histories by clustering devices based on the use history of the devices.

The server 1000 may select some of the features included in the device use history to cluster the device use histories in the device use history database 700. For example, when the server 1000 generates device groups according to the content viewed on the devices, features of the content information and the content-related information (e.g., content viewing time) may be selected. As another example, features for grouping may be selected from among the features included in the use history related to the applications 710, the use history related to the sources 720, and the use history related to the content. The server 1000 may normalize the selected features by the time the feature has been used for each device or the number of times the feature has been used for each device.

The features included in the use history of the device may be high-dimensional data having multiple variables. The server 1000 may apply a dimension reduction algorithm to the normalized features. For example, the server 1000 may reduce the normalized features to two dimensions. For example, the server 1000 may reduce the dimension of the normalized features by using an algorithm such as t-Stochastic Neighbor Embedding (t-SNE). However, the dimension reduction algorithm is not limited thereto.

The server 1000 may perform hierarchical clustering to generate device groups. For example, the server 1000 may calculate the Euclidean distance between devices based on the dimension-reduced features and group adjacent devices. The server 1000 may determine devices included in a cluster as devices of users having similar content preferences.

In operation S720, the server 1000 may identify a group corresponding to the user device among a plurality of device groups based on the use history of the user device 2000.

Among the use history of the user device 2000, the server 1000 may identify features used to determine a plurality of device groups. After normalizing and dimension-reducing the selected features, the server 1000 may calculate a distance to a cluster corresponding to a plurality of device groups to identify a device group to which the user device 2000 belongs.

The server 1000 may identify an editing style preference of the device group identified as corresponding to the user device 2000. For example, the server 1000 may calculate an average editing style preference of the devices in the identified device group. The average of the editing style preference may be calculated for each editing style element. For example, a preference for each editing style element, such as a subtitle preference, a silent section preference, a non-speech segment preference, or an effective viewing segment preference, may be calculated.

In operation S730, the server 1000 may select recommended content based on the preference for the editing style of the selected device group.

In an embodiment of the disclosure, the server 1000 may identify the editing style score calculated for the pieces of edited content stored in the content storage. The server 1000 may match the editing style score for the pieces of edited content with the preference for the editing style of the device group. The server 1000 may select content corresponding to the preference for the editing style from among a content collection including one or more pieces of edited content corresponding to the current content that is being played on the user device 2000.

In an embodiment of the disclosure, the server 1000 may select recommended content by using a combination of the editing style preference of the user device 2000 and the editing style of the device group corresponding to the user device 2000.

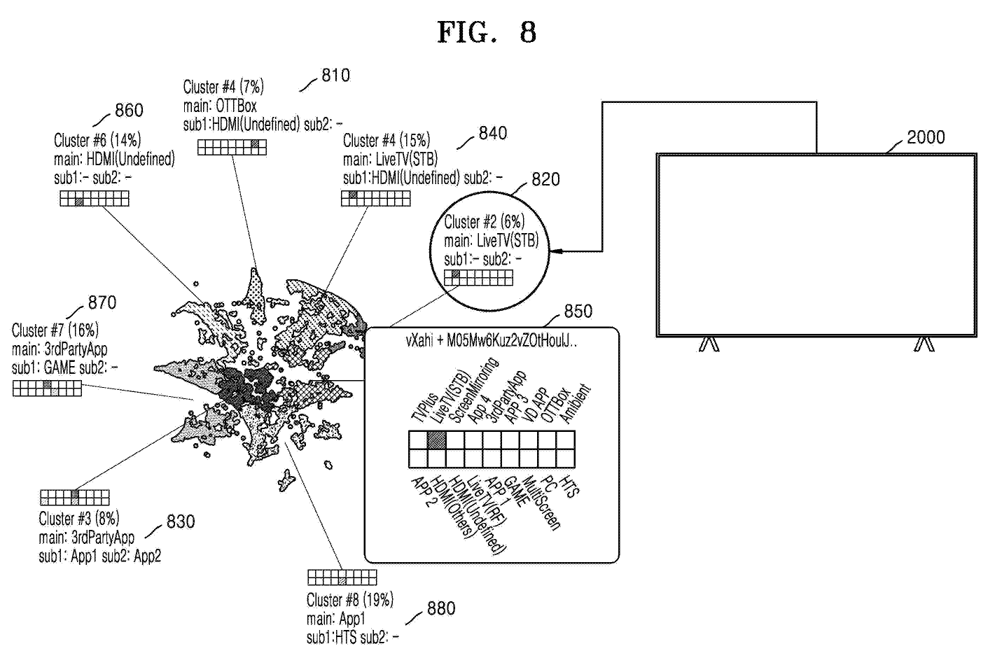

FIG. 8 is a diagram for describing an example of selecting, by a server, a device group corresponding to a user device according to an embodiment of the disclosure.

Referring to FIG. 8, among a plurality of device groups, the server 1000 may identify a group to which the user device 2000 belongs. As an example, the plurality of device groups are described as being determined based on, for example, the use history of applications and the use history of sources among the use histories of the devices. However, a criterion for determining the device group is not limited to the above example. Each device group may include main use history and sub use history information.

For example, the devices classified as belonging to a first device group 810 may have a main use history in which an OTT box has been used in connection with the device, and a sub use history in which an HDMI source has been used in connection with the device. Likewise, each of a second device group 820, a third device group 830, a fourth device group 840, a fifth device group 850, a sixth device group 860, a seventh device group 870, and an eighth device group 880 may include different main use history and sub use history information.

In an embodiment of the disclosure, the server 1000 may analyze the use history of the user device 2000. Based on the analysis result of the use history of the user device 2000, the server 1000 may select a device group corresponding to the user device 2000. For example, as a result of the server 1000 analyzing the use history of applications and the use history of sources among the use histories of the user device, the main use history of the user device may be LiveTV (STB) and there may be no sub use history. In this case, among the plurality of device groups, the second device group 820 may be determined as a device group corresponding to the user device 2000.

In an embodiment of the disclosure, the server 1000 may identify the editing style preference of the device group corresponding to the user device 2000. For example, the server 1000 may identify the editing style preference of the second device group 820 that is a device group corresponding to the user device 2000. The editing style preference of the second device group 820 may be used to determine recommended edited content for the user device 2000.

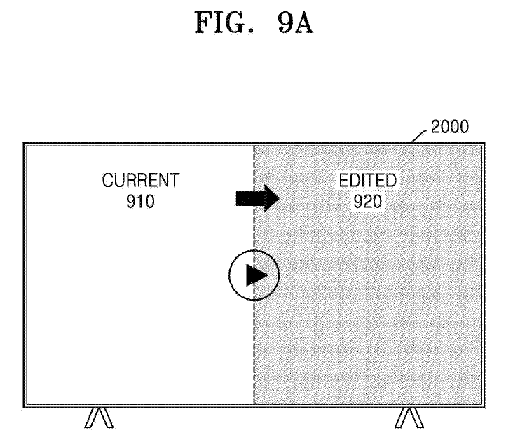

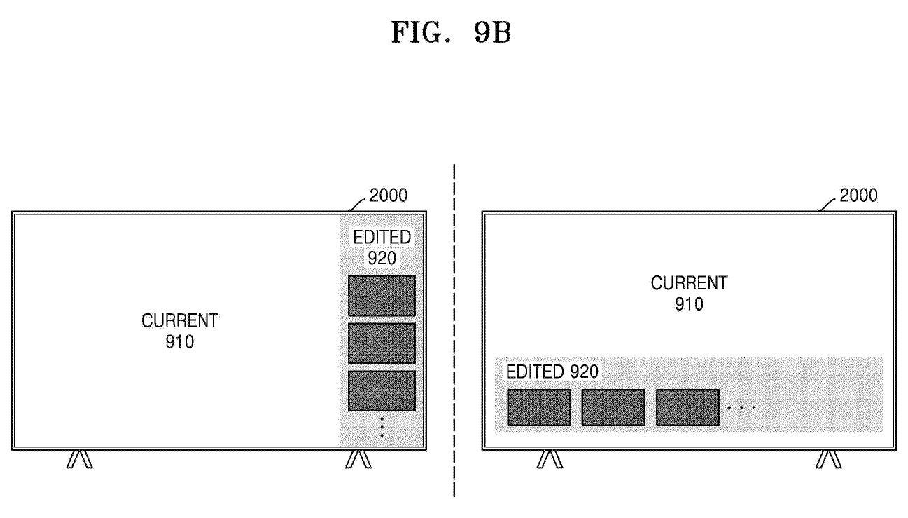

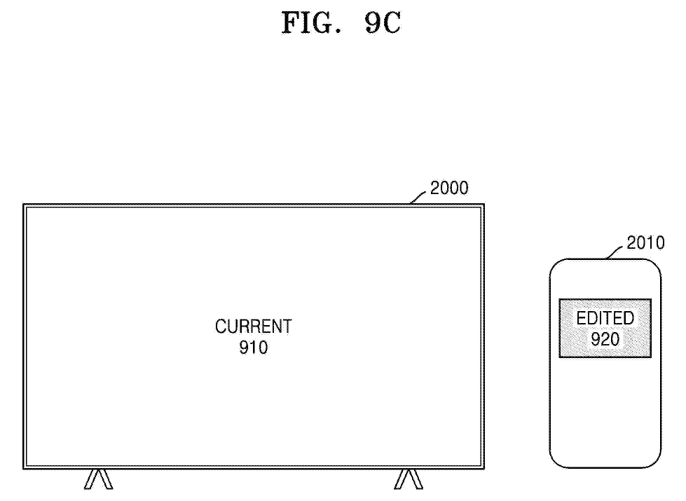

FIG. 9A is a diagram for describing an example of providing, by a user device, recommended edited content according to an embodiment of the disclosure.

The server 1000 may determine recommended content to be provided to the user. The recommended content may be content selected based on a user's preference for an editing style. When identifying that current content 910 is being played, the user device 2000 may request the server 1000 to provide recommended content. The server 1000 may start an operation of determining recommended content based on the request from the user device 2000. When the recommended content is determined, the server 1000 may transmit recommended content information to the user device 2000.

In an embodiment of the disclosure, based on receiving content information about the recommended content from the server 1000, the user device 2000 may change the content being played on the user device 2000 from the current content 910 to edited content 920. The change from the current content 910 to the edited content 920 may be automatically performed. Alternatively, the user device 2000 may provide an option for playing the recommended content through interaction with the user. For example, the user device 2000 may output visual information such as a button of "View recommended content" or output auditory information such as "Would you like to view the recommended content?"

FIG. 9B is a diagram for describing an example of providing, by a user device, recommended edited content according to an embodiment of the disclosure.

In an embodiment of the disclosure, based on receiving content information about the recommended content from the server 1000, the user device 2000 may simultaneously display the current content 910 that is being played on the user device 2000 and the edited content 920 that is the recommended content. The server 1000 may start a recommended content determination operation based on receiving a recommended content providing request from the user device 2000. When the recommended content is determined, the server 1000 may transmit recommended content information to the user device 2000. The recommended content information may be, for example, metadata of content including a thumbnail image.

In an embodiment of the disclosure, based on receiving information about the recommended content from the server 1000, the user device 2000 may render a list of edited content 920 that is the recommended content. As in the examples illustrated in FIG. 9B, the user device 2000 may generate a section for displaying a thumbnail, information, or the like of the edited content 920 beside or below the area of the current content 910. However, the way in which the edited content 920 is displayed is not limited to the above examples.

The user device 2000 may provide a function for playing the recommended content through interaction with the user. For example, when the user selects a thumbnail image of the edited content 920 displayed on the screen of the user device 2000, the user device 200 may move to a detailed information screen of the selected edited content 920 or play the selected edited content 920.

FIG. 9C is a diagram for describing an example of providing, by a user device, recommended edited content according to an embodiment of the disclosure.

In an embodiment of the disclosure, the server 1000 may provide recommended content through a second user device 2010 that is another device, in addition to the user device 2000 in which the current content 910 is being played.

Based on the start of the current content play on the user device 2000, the user device 2000 may request the server 1000 to start a content recommendation algorithm. The server 1000 may determine recommended content and transmit recommended content information to the user device 2000 and/or the second user device 2010. In the example of FIG. 9C, the user device 2000, the second user device 2010, and the server 1000 may be synchronized through a local network.

Based on receiving content information about the recommended content from the server 1000, the second user device 2010 may generate a section capable of displaying a thumbnail, information, or the like of the edited content 920.

The second user device 2010 may provide a function for allowing the recommended content to be played on the first user device 2000 through interaction with the user. For example, when the user selects a thumbnail image of the edited content 920 displayed on the screen of the second user device 2010, the second user device 2010 may display a detailed information screen of the selected edited content 920. Alternatively, the second user device 2010 may allow the edited content 920 to be played on the first user device. In this case, a signal for controlling the first user device 2000 may be transmitted from the second user device 2010 to the first user device 2000 directly or through the server 1000.

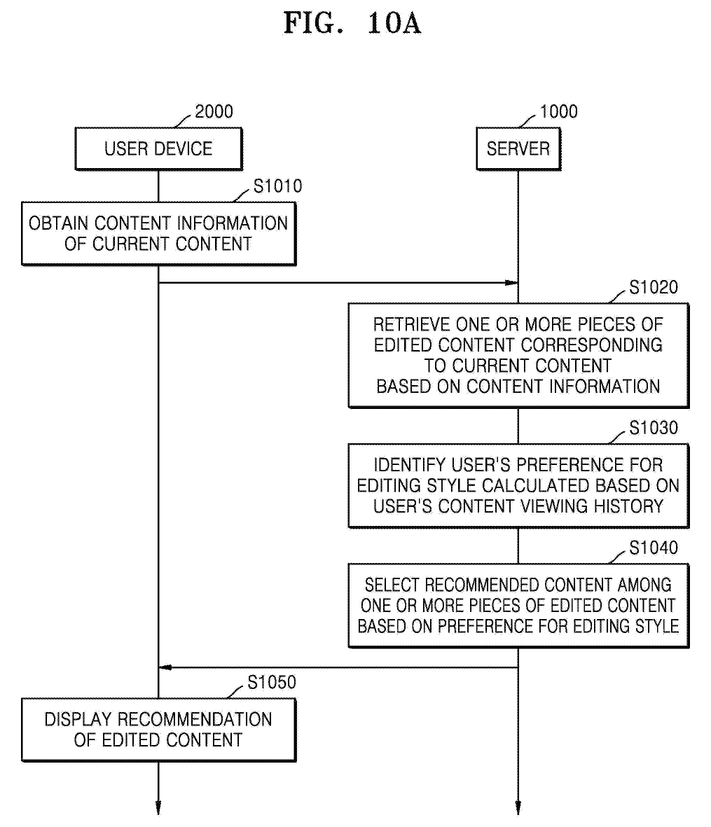

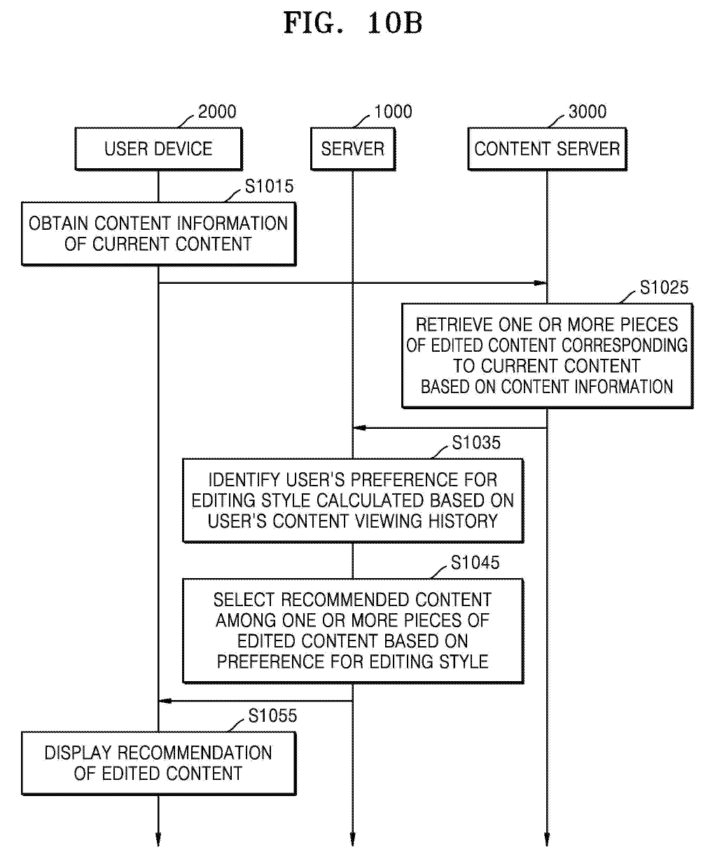

FIG. 10A is a flowchart for describing an example of an operation of a recommended content providing server according to an embodiment of the disclosure.

In an embodiment of the disclosure, an operation of the server 1000 for providing the recommended content may be performed through interaction between the server 1000 and the user device 2000.

In operation S1010, the user device 2000 may obtain content information of the current content. The user device 2000 may transmit the content information of the current content to the server 1000 and request provision of the recommended content. The server 1000 may execute a recommendation algorithm based on receiving the request from the user device 2000.

In operation S1020, the server 1000 may retrieve one or more pieces of edited content corresponding to the current content based on the content information. The pieces of edited content may be stored in the content storage in the server 1000. The pieces of edited content may be pieces of content having the same original source as the current content.

In operation S1030, the server 1000 may identify a user's preference for an editing style calculated based on the user's content viewing history.

In an embodiment of the disclosure, the user's preference for the editing style may be calculated in the user device 2000 and then received by the server 1000. In an embodiment of the disclosure, the server 1000 may receive the user's content viewing history from the user device 2000 and calculate the preference for the editing style. The preference for the editing style may be calculated by at least one of subtitle analysis, non-speech segment analysis, or effective viewing segment analysis.

In operation S1040, the server 1000 may select recommended content among the one or more pieces of edited content based on the preference for the editing style.

With respect to the pieces of edited content stored in the content storage, the server 1000 may calculate an editing style score indicating in which style each piece of content has been edited. The editing style score may include, for example, at least one of a subtitle score, a non-speech segment score, or an effective viewing segment score.

The server 1000 may compare the preference for the editing style with the editing style score and select edited content matching the user's preference. The selected edited content may be provided as recommended content. The server 1000 may transmit information about the recommended content to the user device 2000.

In operation S1050, the user device 2000 may display a recommendation of the edited content. The user device 2000 may perform control such that information indicating the recommendation of the edited content received from the server 1000 is displayed on the screen, or may perform control such that the edited content is played as the recommended content and displayed on the screen.

FIG. 10B is a flowchart for describing an example of an operation of a recommended content providing system according to an embodiment of the disclosure.

In an embodiment of the disclosure, the recommended content providing system may include a server 1000 and a content server 3000. An operation of the server 1000 for providing the recommended content may be performed through interaction between the server 1000, the user device 2000, and the content server 3000.

The content server 3000 may be a server that stores pieces of content and manages a database. The database may store a content file and metadata of the content file in a structured manner.

In operation S1015, the user device 2000 may obtain content information of the current content. The user device 2000 may transmit the content information of the current content to the server 1000 and request retrieval of similar content. The similar content may be edited content having the same original source as the current content being played on the user device 2000.

In operation S1025, the content server 3000 may retrieve one or more pieces of edited content corresponding to the current content based on the content information. Through a content retrieval function, the content server 3000 may retrieve one or more pieces of edited content having the same original source as the current content. The content server 3000 may transmit information about pieces of retrieved edited content to the server 1000.

In operation S1035, the server 1000 may identify a user's preference for an editing style calculated based on the user's content viewing history. The user's preference for the editing style may be calculated by the user device 2000 and then received by the server 1000, or the server 1000 may receive the user's content viewing history from the user device 2000 and calculate the preference for the editing style. The preference for the editing style may be calculated by at least one of subtitle analysis, non-speech segment analysis, or effective viewing segment analysis.

In operation S1045, the server 1000 may select recommended content among the one or more pieces of edited content based on the preference for the editing style.

The server 1000 may select one or more pieces of edited content corresponding to the user's preference for the editing style based on the content information received from the content server 3000 and indicating the content retrieval result. The server 1000 may determine the selected content as recommended content and transmit information about the recommended content to the user device 2000.

In operation S1055, the user device 2000 may display a recommendation of the edited content. The user device 2000 may perform control such that information indicating the recommendation of the edited content received from the server 1000 is displayed on the screen, or may perform control such that the edited content is played as the recommended content and displayed on the screen.

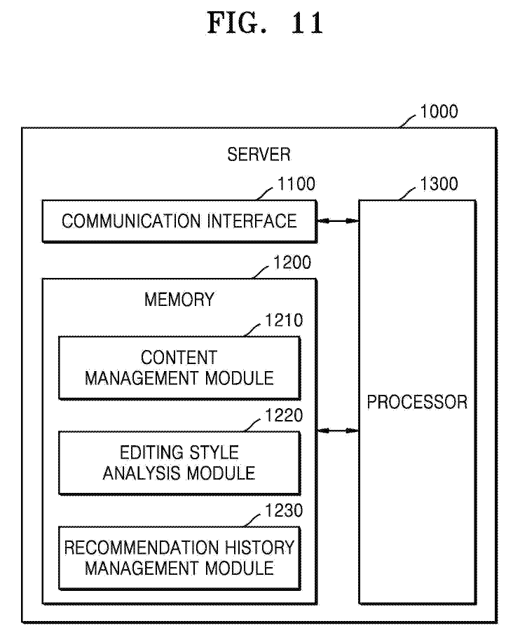

FIG. 11 is a block diagram illustrating a configuration of a server according to an embodiment of the disclosure.

In an embodiment of the disclosure, the server 1000 may include a communication interface 1100, a memory 1200, and a processor 1300.

The communication interface 1100 may perform data communication with other electronic devices under control by the processor 1300. The communication interface 1100 may include a communication circuit.

The communication interface 1100 may perform data communication between the server 1000 and another electronic device (e.g., the user device 2000 or the content server 3000) by using, for example, at least one of data communication methods including wired LAN (e.g., Ethernet), wireless LAN (e.g., WiFi), cellular network (e.g., 4G and 5G), Bluetooth, Bluetooth Low Energy (BLE), ZigBee, infrared communication (Infrared Data Association (IrDA)), Near Field Communication (NFC), RF communication, and various other types of known wireless/wired communication technologies. The communication interface 1100 may include a communication circuit designed to use the above communication methods.

The server 1000 may transmit/receive data for providing recommended content to/from another electronic device (e.g., the user device 2000 or the content server 3000) by using the communication interface 1100.

The memory 1200 may include various types of memories. The memory 1200 may include a main memory that stores data currently being processed in the server 1000. For example, the main memory may include a nonvolatile memory including at least one of a read-only memory (ROM), an electrically erasable programmable read-only memory (EEPROM), and a programmable read-only memory (PROM), and a volatile memory such as a random-access memory (RAM) or a static random-access memory (SRAM). The memory 1200 may include a secondary memory that permanently stores a large amount of data (e.g., a program or a system file). For example, the secondary memory may include, but is not limited to, a hard disk drive (HDD), a solid state drive (SSD), an optical drive (e.g., a compact disk (CD)), and a flash drive.

The memory 1200 may store one or more instructions and one or more programs for causing the server 1000 to operate to select and provide recommended content. For example, the memory 1200 may store instructions and programs for implementing the functions of a content management module 1210, an editing style analysis module 1220, and a recommendation history management module 1230. Moreover, the modules stored in the memory 1200 may be for convenience of description; however, the disclosure is not necessarily limited thereto. Some modules may be omitted and other modules may be added to implement the above embodiments. Also, one module may be divided into a plurality of modules that are distinguished according to detailed functions, and some of the above modules may be combined and implemented as one module.

The processor 1300 may control overall operations of the server 1000. The processor 1300 may include a processing circuitry. For example, by executing one or more instructions of the program stored in the memory 1200, the processor 1300 may control overall operations of the server 1000 for identifying the editing style preference of the user and providing the editing content corresponding to the editing preference as the recommended content. The processor 1300 may include one or more processors.

The processor 1300 may include, for example, at least one of a central processing unit (CPU), a microprocessor, a graphic processing unit (GPU), an application specific integrated circuit (ASIC), a digital signal processor (DSP), a digital signal processing device (DSPD), a programmable logic device (PLD), a field programmable gate array (FPGA), an application processor (AP), a neural processing unit (NPU), or an artificial intelligence-dedicated processor designed in a hardware structure specialized for processing of an artificial intelligence model; however, the disclosure is not limited thereto.

The processor 1300 may execute the content management module 1210 to perform a content management operation. The content management module 1210 may store a content file and metadata of the content file in a structured form. The content management module 1210 may analyze content to identify original content and edited content and may generate a content collection including pieces of content sourced from the same original content. The content management module 1210 may store a history related to the user's content viewing. Because descriptions related to the operations of the content management module 1210 have already been given in the descriptions of the previous drawings, redundant descriptions thereof will be omitted for conciseness.

The processor 1300 may execute the editing style analysis module 1220 to perform an analysis operation on the editing style of the edited content. The editing style analysis module 1220 may analyze editing style elements to calculate an editing style score for each of the pieces of edited content. The editing style elements may include, but are not limited to, a subtitle, a non-speech segment, and a skipped segment. The editing style analysis module 1220 may analyze the user's content viewing history to calculate the user's preference for the editing style. The preference for the editing style may include, but is not limited to, a subtitle preference, a non-speech segment preference, and/or an effective viewing segment preference. Because descriptions related to the operations of the editing style analysis module 1220 have already been given in the descriptions of the previous drawings, redundant descriptions thereof will be omitted for conciseness.

The processor 1300 may execute the recommendation history management module 1230 to perform a storage and update operation on the recommendation history. The recommendation history management module 1230 may update the user's preference for the editing style based on information related to the recommended content provided to the user device 2000 and/or the content viewed on the user device 2000 and may update the recommendation content list based on the preference for the updated editing style. Because descriptions related to the operations of the recommendation history management module 1230 have already been given in the descriptions of the previous drawings, redundant descriptions thereof will be omitted for conciseness.

In an embodiment of the disclosure, the processor 1300 may include one or more processors. When the processor 1300 includes one or more processors, the operations of the disclosure may be performed by the one or more processors individually or collectively executing the instructions and/or programs stored in the memory 1200. When the method according to an embodiment of the disclosure includes a plurality of operations, the plurality of operations may be performed by one processor 1300 or may be performed by a plurality of processors 1300.

For example, when a first operation, a second operation, and a third operation are performed by the method according to an embodiment of the disclosure, all of the first operation, the second operation, and the third operation may be performed by a first processor, or some of the first to third operations may be performed by a first processor (e.g., a general-purpose processor) and the other operations may be performed by a second processor (e.g., an artificial intelligence-dedicated processor). Here, operations for training/inference of an artificial intelligence model may be performed by an artificial intelligence-dedicated processor that is an example of the second processor. However, an embodiment of the disclosure is not limited thereto.

One or more processors according to the disclosure may be implemented as a single-core processor or a multi-core processor. When the method according to an embodiment of the disclosure includes a plurality of operations, the plurality of operations may be performed by one core or may be performed by a plurality of cores included in one or more processors.

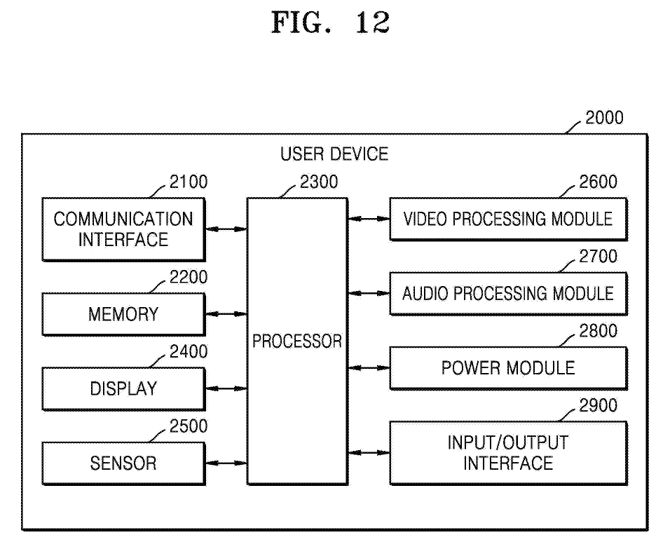

FIG. 12 is a block diagram illustrating a configuration of a user device according to an embodiment of the disclosure.

In an embodiment of the disclosure, the user device 2000 may include a communication interface 2100, a memory 2200, a processor 2300, a display 2400, a sensor 2500, a video processing module 2600, an audio processing module 2700, a power module 2800, and an input/output interface 2900.

The communication interface 2100 may perform data communication with other electronic devices under control by the processor 2300. The communication interface 2100 may include a communication circuit.

The communication interface 2100 may perform data communication between the user device 2000 and another electronic device (e.g., the server 1000 or the content server 3000) by using, for example, at least one of data communication methods including wired LAN (e.g., Ethernet), wireless LAN (e.g., WiFi), cellular network (e.g., 4G and 5G), Bluetooth, Bluetooth Low Energy (BLE), ZigBee, infrared communication (Infrared Data Association (IrDA)), Near Field Communication (NFC), RF communication, and various other types of known wireless/wired communication technologies. The communication interface 2100 may include a communication circuit designed to use the above communication methods.

The memory 2200 may include various types of memories. The memory 2200 may include a main memory that stores data currently being processed in the user device 2000. For example, the main memory may include a nonvolatile memory including at least one of a read-only memory (ROM), an electrically erasable programmable read-only memory (EEPROM), and a programmable read-only memory (PROM), and a volatile memory such as a random-access memory (RAM) or a static random-access memory (SRAM). The memory 2200 may include a secondary memory that permanently stores a large amount of data (e.g., a program or a system file). For example, the secondary memory may include, but is not limited to, a hard disk drive (HDD), a solid state drive (SSD), an optical drive (e.g., a compact disk (CD)), and a flash drive.

The processor 2300 may control overall operations of the user device 2000. The processor 2300 may include a processing circuit. The processor 2300 may include one or more processors.

The processor 2300 may include, for example, at least one of a central processing unit (CPU), a microprocessor, a graphic processing unit (GPU), an application specific integrated circuit (ASIC), a digital signal processor (DSP), a digital signal processing device (DSPD), a programmable logic device (PLD), a field programmable gate array (FPGA), an application processor (AP), a neural processing unit (NPU), or an artificial intelligence-dedicated processor designed in a hardware structure specialized for processing of an artificial intelligence model, however, the disclosure is not limited thereto.

The display 2400 may output an image signal to the screen of the user device 2000 under control by the processor 2300. For example, the user device 2000 may output a user interface including one or more pieces of recommended content through the display 2400.

The sensor 2500 may obtain sensor data. The sensor 2500 may include one or more sensors. The processor 2300 may process the sensor data to obtain information. The sensor may include, but is not limited to, an IR receiver for detecting a remote control signal.

The video processing module 2600 may perform processing on video data played by the user device 2000. The video processing module 2600 may perform various image/video processings such as decoding, scaling, noise removal, frame rate conversion, resolution conversion, and rendering on the video data. The display 2400 may generate a driving signal by converting an image signal, a data signal, an on-screen display (OSD) signal, or a control signal processed by the processor 2300 and display an image according to the driving signal.

The audio processing module 2700 may perform processing on audio data played by the user device 2000. The audio processing module 2700 may perform various processings such as decoding, amplification, and noise reduction on the audio data.

The power module 2800 may supply power, which is input from an external power source, to the internal components of the user device 2000 under control by the processor 2300. Also, the power module 2800 may supply power, which is output from one or more batteries located in the user device 2000, to the internal components under control by the processor 2300.

The input/output interface 2900 may process the input/output from the outside of the user device 2000. The input/output interface 2900 may receive video (e.g., moving images), audio (e.g., voice and music), and additional information (e.g., electronic program guide (EPG)). The input/output interface 2900 may include any one of Universal Serial Bus (USB), High-Definition Multimedia Interface (HDMI), Mobile High-definition Link (MHL), Display Port (DP), Thunderbolt, a Video Graphics Array (VGA) port, an RGB port, D-subminiature (D-SUB), Digital Visual Interface (DVI), a component jack, a PC port, and an audio jack. That is, the input/output interface 2900 may be implemented to include a plurality of modules (e.g., a USB port and an HDMI port) for implementing the above input/output methods. The user device 2000 may be connected through the input/output interface 2900 to external devices such as a display, a camera, a microphone, a speaker, and a touch pad.

The user device 2000 may include various types of devices including the display 2400. For example, the user device 2000 may include a TV, a smart monitor, a tablet PC, a laptop PC, a digital signage, a large display, a 360-degree projector, and a smartphone. In an embodiment of the disclosure, the user device 2000 may be implemented without the display 2400. The user device 2000 may include, but is not limited to, a set-top box and a desktop PC that may be connected to a separate external display.

In an embodiment of the disclosure, the operations of the server 1000 described above may be replaced by the operations executed in the user device 2000. For example, the user device 2000 may store programs and instructions corresponding to a content management module, an editing style analysis module, and a recommendation history management module to perform functions the same as/similar to those of the server 1000.

In an embodiment of the disclosure, the user device 2000 may obtain content information of a current content being viewed by the user and retrieve one or more pieces of edited content corresponding to the current content based on the content information. The pieces of edited content may be stored in the user device 2000 or may be stored in a separate external device (e.g., the server 1000 or the content server 3000). The user device 2000 may identify the user's preference for the editing style calculated based on the user's content viewing history, select recommended content from the one or more pieces of edited content based on the preference for the editing style, and perform control such that a recommendation of the edited content is displayed.

Detailed operations for the user device 2000 to recommend edited content corresponding to the user's editing style preference may be inferred and applied by the operations of the server 1000 described above, and thus, redundant descriptions thereof will be omitted for conciseness.

The disclosure relates to a server that identifies content being played on the user device and provides a recommendation of edited content corresponding to the user's editing style preference based on the identified content. The recommended content may be edited content sourced from the same original version as the current content being played on the user device. Technical solutions to be achieved by the disclosure are not limited to the technical solutions mentioned above, and other technical solutions not mentioned above may be clearly understood from the description of the disclosure by those of ordinary skill in the art.

According to an aspect of the disclosure, a method of providing, by a server, user-preferred content may be provided.

The method may include retrieving, based on content information of current content, one or more pieces of edited content corresponding to the current content.

The method may include identifying a preference for an editing style, the preference being based on a viewing history.

The method may include identifying and providing recommended content among the one or more pieces of edited content based on the preference for the editing style.

The method may include identifying original content and pieces of edited content corresponding to the original content.

The method may include analyzing one or more editing style elements and obtaining an editing style score for each of the pieces of edited content.

The identifying and providing of the recommended content may include identifying the recommended content based on the editing style score obtained for the one or more pieces of edited content.

The method may include identifying pieces of similar content based on similarities between a plurality of pieces of content in a storage.

The method may include identifying original content and pieces of edited content among the pieces of similar content based on one or more defined conditions.

The identifying of the preference for the editing style may include analyzing subtitles included in the edited content of the viewing history of the user, to obtain a preference for subtitles.

The identifying of the preference for the editing style may include analyzing a non-speech segment of the edited content of the viewing history of the user, to obtain a preference for the non-speech segment.

The identifying of the preference for the editing style may include analyzing a viewing section of the edited content of the viewing history of the user, to obtain a preference for an effective viewing segment.

The method may include identifying a plurality of device groups of devices with similar use histories by clustering devices, the clustering of the devices being based on use histories of the devices.

The method may include identifying a group corresponding to a user device among the plurality of device groups based on a use history of the user device.

The identifying and providing of the recommended content may include identifying the recommended content based on a preference for an editing style of the identified device group.

The identifying of the plurality of device groups may include identifying features to be used for clustering among features of the use histories of the devices, based on content information viewed on the user device.

The identifying and providing of the recommended content may include providing a recommended content list including the one or more pieces of edited content.

The method may include editing the current content based on the preference for the editing style.

The identifying and providing of the recommended content may include providing the edited current content as the recommended content.

According to an aspect of the disclosure, a server for providing user-preferred content may be provided.

The server may include a communication interface, at least one processor, and a memory storing instructions.

By executing the instructions by the at least one processor, the server may retrieve, based on content information of current content, one or more pieces of edited content corresponding to the current content.

By executing the instructions by the at least one processor, the server may identify a preference for an editing style, the preference being based on a viewing history.

By executing the instructions by the at least one processor, the server may identify and provide recommended content among the one or more pieces of edited content based on the preference for the editing style.

By executing the instructions by the at least one processor, the server may identify original content and pieces of edited content corresponding to the original content.

By executing the instructions by the at least one processor, the server may analyze one or more editing style elements and obtain an editing style score for each of the pieces of edited content.

By executing the instructions by the at least one processor, the server may identify the recommended content based on the editing style score obtained for the one or more pieces of edited content.

By executing the instructions by the at least one processor, the server may identify pieces of similar content by comparing similarities between a plurality of pieces of content in a content storage.

By executing the instructions by the at least one processor, the server may identify original content and pieces of edited content among the pieces of similar content based on one or more defined conditions.

By executing the instructions by the at least one processor, the server may analyze subtitles included in the edited content of the viewing history of the user, to obtain a preference for subtitles.

By executing the instructions by the at least one processor, the server may analyze a non-speech segment of the edited content of the viewing history of the user, to obtain a preference for a non-speech segment.

By executing the instructions by the at least one processor, the server may analyze a viewing section of the edited content of the viewing history of the user, to obtain a preference for an effective viewing segment.

By executing the instructions by the at least one processor, the server may identify a plurality of device groups of devices with similar use histories by clustering devices, the clustering of the devices being based on use histories of the devices.

By executing the instructions by the at least one processor, the server may identify a group corresponding to a user device among the plurality of device groups based on a use history of the user device.

By executing the instructions by the at least one processor, the server may identify the recommended content based on a preference for an editing style of the identified device group.

By executing the instructions by the at least one processor, the server may identify features to be used for clustering among features of the use histories of the devices, based on content information viewed on the user device.

By executing the instructions by the at least one processor, the server may provide a recommended content list including the one or more pieces of edited content.

By executing the instructions by the at least one processor, the server may edit the current content based on the preference for the editing style.

By executing the instructions by the at least one processor, the server may provide the edited current content as the recommended content.

The embodiments of the disclosure may also be implemented in the form of a computer-readable recording medium including instructions executable by a computer, such as program modules executed by a computer. The computer-readable recording mediums may be any available mediums accessible by computers and may include both volatile and non-volatile mediums and detachable and non-detachable mediums. Also, the computer-readable recording mediums may include computer storage mediums and communication mediums. The computer storage mediums may include both volatile and non-volatile and detachable and non-detachable mediums implemented by any method or technology for storage of information such as computer-readable instructions, data structures, program modules, or other data. The communication medium may generally include computer-readable instructions, data structures, or other data of modulated data signals such as program modules.

Also, the computer-readable storage medium may be provided in the form of a non-transitory storage medium. Here, the term "non-transitory storage medium" may mean that the storage medium is a tangible device and does not include signals (e.g., electromagnetic waves), and may mean that data may be semipermanently or temporarily stored in the storage medium. For example, the "non-transitory storage medium" may include a buffer in which data is temporarily stored.

According to an embodiment of the disclosure, the method according to various embodiments of the disclosure described herein may be included and provided in a computer program product. The computer program product may be traded as a product between a seller and a buyer. The computer program product may be distributed in the form of a machine-readable storage medium or may be distributed (e.g., downloaded or uploaded) online through an application store or directly between two user devices (e.g., smartphones). In the case of online distribution, at least a portion of the computer program product (e.g., a downloadable app) may be at least temporarily stored or temporarily generated in a machine-readable storage medium such as a manufacturer's server, a server of an application store, or a memory of a relay server.

The foregoing descriptions of the disclosure are merely examples, and those of ordinary skill in the art will readily understand that various modifications may be made therein without materially departing from the spirit or features of the disclosure. Therefore, it is to be understood that the embodiments described above should be considered in a descriptive sense only and not for purposes of limitation. For example, each component described as a single type may also be implemented in a distributed manner, and likewise, components described as being distributed may also be implemented in a combined form.

The scope of the disclosure is defined not by the above detailed description but by the following claims, and all modifications derived from the meaning and scope of the claims and equivalent concepts thereof should be construed as being included in the scope of the disclosure.

1. A method, performed by a server, the method comprising:
retrieving, based on content information of current content being played on a user device, one or more pieces of edited content corresponding to the current content;
identifying a preference for an editing style, the preference being based on a viewing history;
identifying recommended content among the one or more pieces of edited content, based on the preference for the editing style; and
transmitting information about the recommended content to the user device.

2. The method of claim 1, further comprising:
identifying original content and pieces of edited content corresponding to the original content; and
analyzing one or more editing style elements and obtaining an editing style score for each of the pieces of edited content,
wherein the identifying the recommended content comprises identifying the recommended content, based on the editing style score obtained for the one or more pieces of edited content.

3. The method of claim 2, further comprising:
identifying pieces of similar content, based on similarities between a plurality of pieces of content in a storage; and
identifying the original content and the pieces of edited content among the pieces of similar content, based on one or more defined conditions.

4. The method of claim 2, wherein the identifying of the preference for the editing style comprises analyzing subtitles included in the pieces of edited content that are included in the viewing history of the user, to obtain a preference for subtitles.

5. The method of claim 2, wherein the identifying of the preference for the editing style comprises analyzing a non-speech segment of the pieces of edited content that are included in the viewing history of the user, to obtain a preference for the non-speech segment.

6. The method of claim 2, wherein the identifying of the preference for the editing style comprises analyzing a viewing section of the pieces of edited content that are included in the viewing history of the user, to obtain a preference for an effective viewing segment.

7. The method of claim 1, further comprising:
identifying a plurality of device groups of devices with similar use histories by clustering devices, the clustering of the devices being based on use histories of the devices; and
identifying a group corresponding to the user device among the plurality of device groups, based on a use history of the user device,
wherein the identifying the recommended content comprises identifying the recommended content, based on a preference for an editing style of the identified device group.

8. The method of claim 7, wherein the identifying of the plurality of device groups comprises identifying features to be used for clustering among features of the use histories of the devices, based on content information viewed on the user device.

9. The method of claim 1, wherein the transmitting of the information about the recommended content comprises transmitting a recommended content list including the one or more pieces of edited content.

10. The method of claim 1, further comprising:
editing the current content, based on the preference for the editing style,
wherein the transmitting of information about the recommended content comprises transmitting the edited current content as the recommended content.

11. A server comprising:
a communication interface;
at least one processor; and
a memory storing instructions,
wherein the instructions, when executed by the at least one processor, cause the server to:
retrieve, based on content information of current content being played on a user device, one or more pieces of edited content corresponding to the current content, wherein the content information is received from the user device through the communication interface,
identify a preference for an editing style, the preference being based on a viewing history,
identify recommended content among the one or more pieces of edited content, based on the preference for the editing style, and
transmit, through the communication interface, information about the recommended content to the user device.

12. The server of claim 11, wherein the instructions, when executed by the at least one processor, cause the server to:
identify original content and pieces of edited content corresponding to the original content,
analyze one or more editing style elements and obtain an editing style score for each of the pieces of edited content, and,
identify the recommended content, based on the editing style score obtained for the one or more pieces of edited content.

13. The server of claim 12, wherein the instructions, when executed by the at least one processor, cause the server to:
identify pieces of similar content, based on similarities between a plurality of pieces of content in a storage, and
identify the original content and the pieces of edited content among the pieces of similar content, based on one or more defined conditions.

14. The server of claim 12, wherein the instructions, when executed by the at least one processor, cause the server to:
analyze subtitles included in the pieces of edited content that are included in the viewing history of the user, to obtain a preference for subtitles.

15. The server of claim 12, wherein the instructions, when executed by the at least one processor, cause the server to:
analyze a non-speech segment of the pieces of edited content that are included in the viewing history of the user, to obtain a preference for a non-speech segment.

16. The server of claim 12, wherein the instructions, when executed by the at least one processor, cause the server to:
analyze a viewing section of the pieces of edited content that are included in the viewing history of the user, to obtain a preference for an effective viewing segment.

17. The server of claim 11, wherein the instructions, when executed by the at least one processor, cause the server to:
identify a plurality of device groups of devices with similar use histories by clustering devices, the clustering of the devices being based on use histories of the devices,
identify a group corresponding to the user device among the plurality of device groups, based on a use history of the user device, and,
identify the recommended content, based on a preference for an editing style of the identified device group.

18. The server of claim 17, wherein the instructions, when executed by the at least one processor, cause the server to:
identify features to be used for clustering among features of the use histories of the devices, based on content information viewed on the user device.

19. The server of claim 11, wherein the instructions, when executed by the at least one processor, cause the server to:
transmit, through the communication interface, a recommended content list including the one or more pieces of edited content.

20. A non-transitory computer-readable recording medium having recorded thereon a program for causing a computer to execute a method comprising:
retrieving, based on content information of current content being played on a user device, one or more pieces of edited content corresponding to the current content;
identifying a preference for an editing style, the preference being based on a viewing history;
identifying recommended content among the one or more pieces of edited content, based on the preference for the editing style; and
transmitting information about the recommended content to the user device.
